(19) United States
(12) Patent Application Publication
(10) Pub. No.: US 2018/0017017 A1
(43) Pub. Date: Jan. 18, 2018

(54) RAMBURNING ENGINE WITH INLET TURBINE

(71) Applicant: Rolls-Royce North American Technologies Inc., Indianapolis, IN (US)

(72) Inventors: Steven Wesley Tomlinson, Brownsburg, IN (US); Victor Lewis Oechsle, Avon, IN (US)

(73) Assignee: Rolls Royce North American Technologies Inc., Indianapolis, IN (US)

(21) Appl. No.: 15/208,141

(22) Filed: Jul. 12, 2016

(51) Int. Cl. F02K 1/46; F02C 3/04; F23R 3/28; F02C 7/057; F02C 9/18

(52) U.S. Cl. CPC F02K 1/46; F02C 7/057; F02C 9/18; F23R 3/28; F02C 3/04; F05D 2220/80; F05D 2240/35; F05D 2220/323

(57) ABSTRACT

A gas turbine engine assembly for high Mach number operation comprising an inlet turbine assembly, a gas turbine engine core, and a ramburner arranged along a common axis. During high Mach number operation, working fluid flow is selectively directed through the inlet turbine assembly to cool the working fluid prior to entry in the gas turbine engine core. Working fluid exiting the gas turbine engine core may be reheated by a ramburner for thrust augmentation.

### RELATED APPLICATIONS

The present disclosure is a non-provisional of and claims priority to U.S. Provisional Patent Application No. 62/286,725, filed Jan. 25, 2016, and to U.S. Provisional Patent Application No. 62/295,857, filed Feb. 16, 2016, each of which is herein incorporated by reference in its entirety.

### GOVERNMENT RIGHTS

This invention was made with Government support under Government contract number FA8650-15-D-2503 awarded by the Department of the Air Force. The Government may have certain rights in this invention.

### FIELD OF THE DISCLOSURE

The present disclosure relates generally to gas turbine engines, and more specifically to high Mach number gas turbine engines adapted for use in very high-speed air vehicles.

### BACKGROUND

High Mach number gas turbine engines are used to power aircraft, projectiles, and the like. These high Mach number gas turbine engines typically include an engine core with a compressor, a combustor, and a turbine. The compressor compresses air drawn into the engine and delivers high pressure air to the combustor. In the combustor, fuel is mixed with the high pressure air and is ignited producing hot, high temperature gasses to drive the turbine and to provide thrust that propels the engine.

Travelling at supersonic speeds involves high stagnation temperatures and can lead to increased friction between the high Mach number gas turbine engines and the atmosphere which heats the air entering the engine core to extreme temperatures. Exposing components of the engine core to these extreme temperatures can lead to decreased performance or engine failure. To overcome the damaging temperatures, various cooling methods have been employed to remove the heat from the working fluid before entering the gas turbine engine. However, the increased weight and maintenance from these methods, such as heat exchangers and refrigeration systems, lead to decreased vehicle performance.

In some applications it may also be desirable to reheat the air after it passes through the gas turbine engine. Air may therefore be cooled prior to entering the gas turbine engine to prevent engine performance degradation and engine damage associated with extreme temperatures, and the air may then be reheated upon exiting the gas turbine engine for thrust augmentation.

### SUMMARY

The present application discloses one or more of the features recited in the appended claims and/or the following features which, alone or in any combination, may comprise patentable subject matter.

According to an aspect of the present disclosure, a high Mach number engine comprises a gas turbine core including a compressor, a combustor, and a turbine; an inlet assembly coupled to the gas turbine core and configured to selectively remove energy from a working fluid prior to entering the gas turbine core when the high Mach number engine is travelling at high speeds; and a ramburner assembly coupled to the gas turbine core and configured to selectively mix the working fluid with a bypass air upon exiting the gas turbine core and add energy to the working fluid for thrust augmentation.

In some embodiments the inlet assembly comprises an inlet turbine disposed in an inlet turbine casing and an inlet flow director configured to selectively permit working fluid to flow through the inlet turbine. In some embodiments the high Mach number engine further comprises an inlet turbine load component coupled to the inlet turbine. In some embodiments the high Mach number engine further comprises an engine casing which encases the inlet turbine assembly and the gas turbine core, wherein an inlet turbine passageway is defined within the inlet turbine casing and an inlet bypass passageway is defined between the engine casing and the inlet turbine casing and is coaxial with the inlet turbine casing, and wherein the high Mach number engine further comprises a core flow director movable from (i) an open position arranged to allow working fluid from the inlet bypass passageway to move through the inlet bypass passageway and enter the gas turbine core without interacting with the inlet turbine to (ii) a closed position arranged to block air from moving through the inlet bypass passageway into the gas turbine core.

In some embodiments the inlet turbine is configured to be driven by working fluid moving through the inlet turbine passageway thereby removing energy from the working fluid, and wherein the turbine load component is configured to apply a load on the inlet turbine. In some embodiments the ramburner assembly comprises a fuel injection module and an exhaust nozzle which defines a ramburning combustion chamber. In some embodiments the ramburner assembly further comprises a bypass flow director configured to selectively permit flow of working fluid in a bypass passageway into the ramburning combustion chamber. In some embodiments the bypass flow director comprises a collar mounted to slide along a central axis from an open position to a closed position. In some embodiments the bypass flow director is configured to throttle flow of the bypass air into the ramburning combustion chamber. In some embodiments the high Mach number engine further comprises a controller coupled to the inlet assembly and the ramburner assembly to selectively configure the high

Mach number engine for high Mach number operations.

According to another aspect of the present disclosure, a high Mach number engine comprises a gas turbine core including a compressor, a combustor and a turbine; an inlet assembly including an inlet turbine arranged between the gas turbine core and atmosphere and a core flow director movable from (i) an opened position arranged to allow air from the atmosphere to enter the gas turbine core without interacting with the inlet turbine to (ii) a closed position arranged to block air from the atmosphere from entering the gas turbine core without interacting with the inlet turbine; and a ramburner assembly coupled to the gas turbine core and configured to selectively mix the air upon exiting the gas turbine core with a bypass air and to selectively return energy to the air mixture for thrust augmentation.

In some embodiments the ramburner assembly comprises a fuel injection module configured to inject fuel into the air exhausted from the gas turbine core to create an air-fuel mixture and a ramburning combustion chamber where the air-fuel mixture is combusted to provide thrust augmentation. In some embodiments the gas turbine core and ramburner assembly are at least partially disposed within a core casing which defines a core flowpath, and wherein the core casing is disposed within and concentric with an engine assembly casing such that a bypass flowpath is defined between the engine assembly casing and the core casing. In some embodiments the high Mach number engine further comprises a bypass flow director configured to selectively permit flow of air in the bypass flowpath into the ramburning combustion chamber. In some embodiments the bypass flow director comprises a collar mounted to slide along a central axis, the collar configured to variably control the volume of air in the bypass flowpath which is permitted to enter the ramburning combustion chamber.

According to another aspect of the present disclosure, a method is presented of operating an engine comprising an inlet assembly, a gas turbine core, and a ramburner assembly. The method comprises detecting the Mach number of the engine moving through a surrounding atmosphere with a sensor coupled to a controller; upon detecting the high Mach number engine moving at a predetermined Mach number: moving a core flow director from an opened position wherein air can flow from atmosphere to a gas turbine core without interacting with an inlet turbine to a closed position forcing air to interact with the inlet turbine to cool the air before reaching the gas turbine core; mixing the gas turbine core exit air with bypass air; and energizing the mixed air to provide thrust augmentation.

In some embodiments the method further comprises, upon detecting the engine moving at a predetermined speed Mach number, moving an inlet flow director from a closed position which prevents air flow across an inlet turbine to an open position which permits air flow across an inlet turbine. In some embodiments the step of reenergizing air exiting the gas turbine core comprising injecting fuel into the air in the ramburner assembly to form a fuel-air mixture and combusting the fuel-air mixture in the ramburner assembly. In some embodiments the method further comprises, upon detecting the engine moving at a predetermined Mach number, throttling the flow of air in a bypass flowpath into the ramburner assembly to aide in reenergizing of air exiting the gas turbine core. In some embodiments the throttling of air is performed by a bypass flow director comprising a collar mounted to slide along a central axis and configured to slide continuously between an open position and a shut position.

### BRIEF DESCRIPTION OF THE DRAWINGS

The following will be apparent from elements of the figures, which are provided for illustrative purposes and are not necessarily to scale.

FIG. 1A is a schematic view of a gas turbine engine assembly configured for low Mach number operation in accordance with some embodiments of the present disclosure.

FIG. 1B is a schematic view of a gas turbine engine assembly configured for low Mach number operation and illustrating the fluid flowpaths within the gas turbine engine assembly in accordance with some embodiments of the present disclosure.

FIG. 2A is a schematic view of a gas turbine engine assembly configured for high Mach number operation in accordance with some embodiments of the present disclosure.

FIG. 2B is a schematic view of a gas turbine engine assembly configured for high Mach number operation and illustrating the fluid flowpaths within the gas turbine engine assembly in accordance with some embodiments of the present disclosure.

FIG. 3 is a cross sectional view of a high Mach number engine that includes a gas turbine core, an inlet turbine adapted to cool air that enters the gas turbine core when the high Mach number engine is travelling at a relatively high rate of speed, and a core flow director configured to selectively allow air to bypass the inlet turbine when the high Mach number engine is travelling at a relatively low rate of speed, and further showing that the core flow director is illustratively provided by a collar mounted to slide along a central engine axis as suggested in FIGS. 4 and 5.

FIG. 4 is a detailed view of a portion of FIG. 3 showing that structure of an inlet assembly, which includes the inlet turbine and the core flow director, defines an inlet turbine passageway arranged to conduct atmospheric air that interacts with the inlet turbine on its way to the engine core and a bypass passageway arranged to conduct atmospheric air that bypasses the inlet turbine on its way to the engine core, and showing that the core flow director is in an opened position allowing air to move through the bypass passageway into the gas turbine core (as it would when the high Mach number gas turbine engine is travelling at a relatively low rate of speed).

FIG. 5 is a view similar to FIG. 4 with the core flow director moved to a closed position by sliding along the central engine axis showing the core flow director blocking air from moving through the bypass passageway into the gas turbine core so that air entering the gas turbine core interacts with the inlet turbine to be cooled (as it would when the high Mach number gas turbine engine is travelling at a relatively high rate of speed).

FIG. 6A is a cross sectional view of a ramburner assembly in accordance with some aspects of the present disclosure.

FIG. 6B is a cross sectional view of a ramburner assembly in accordance with some aspects of the present disclosure.

While the present disclosure is susceptible to various modifications and alternative forms, specific embodiments have been shown by way of example in the drawings and will be described in detail herein. It should be understood, however, that the present disclosure is not intended to be limited to the particular forms disclosed. Rather, the present disclosure is to cover all modifications, equivalents, and alternatives falling within the spirit and scope of the disclosure as defined by the appended claims.

### DETAILED DESCRIPTION

For the purposes of promoting an understanding of the principles of the disclosure, reference will now be made to a number of illustrative embodiments illustrated in the drawings and specific language will be used to describe the same.

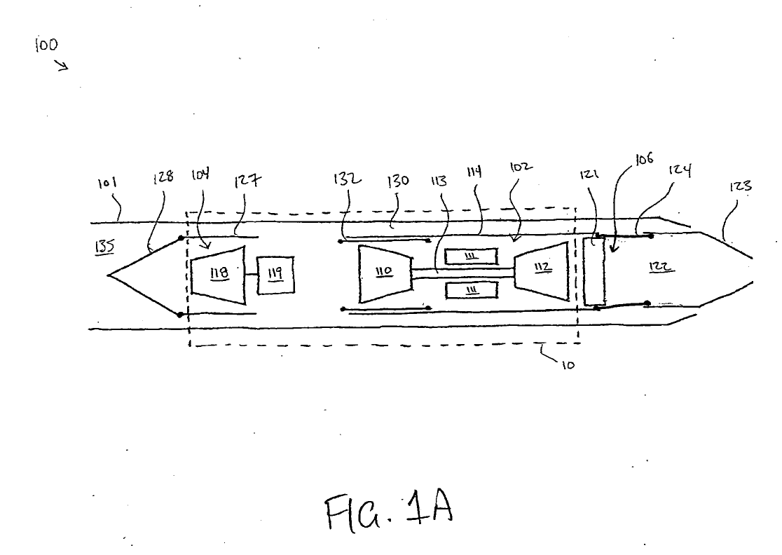

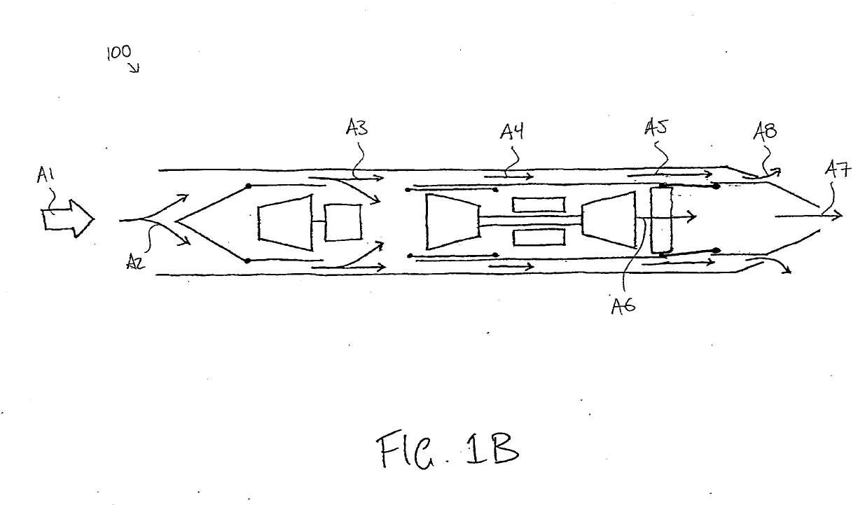

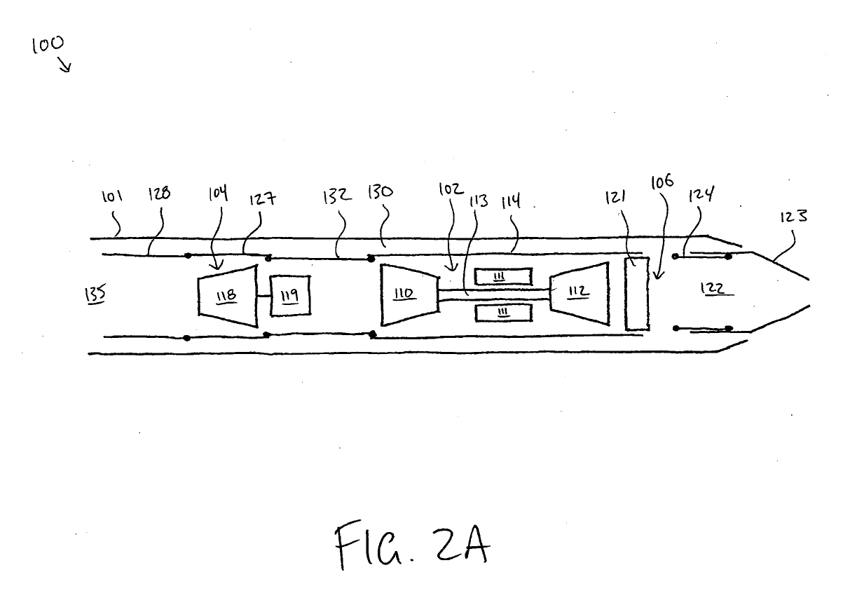

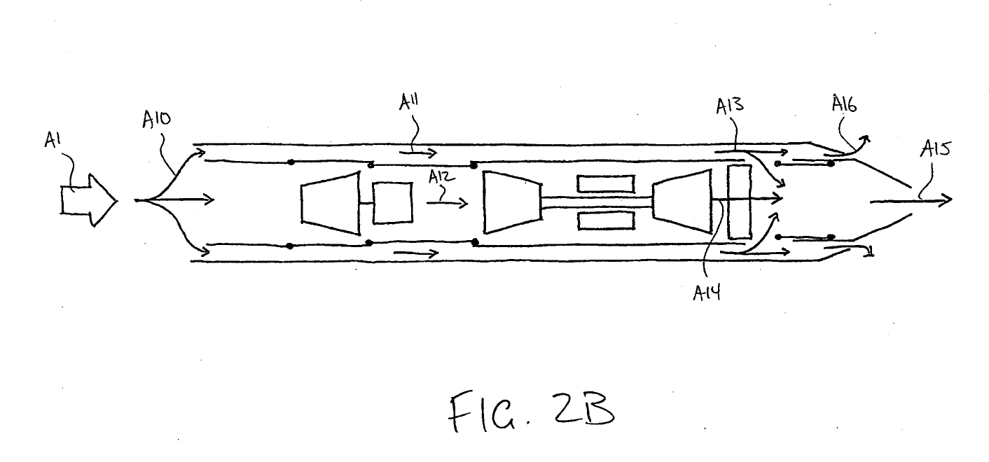

This disclosure presents systems and methods of operation for a ramburning engine with an inlet turbine which overcomes the deficiencies noted above. More specifically, present disclosure is directed to a ramburning engine having an inlet turbine adapted to selectively cool air that enters the gas turbine core and having a ramburner to selectively reheat air exiting the gas turbine core. Such a ramburning engine is schematically depicted in FIGS. 1A, 1B, 2A, and 2B.

FIG. 1A is a schematic view of a gas turbine engine assembly 100 configured for low Mach number operation. Gas turbine engine assembly 100 comprises a gas turbine engine core 102, an inlet turbine assembly 104, and a ramburner assembly 106 arranged along an axis A with the inlet turbine assembly 104 axially forward and the ramburner assembly 106 axially aft of the gas turbine engine core 102. Gas turbine engine assembly 100 is disposed within an engine assembly casing 101.

Gas turbine engine core 102 comprises a compressor 110, a combustor 111, and a turbine 112 disposed within a core casing 114. Compressor 110 and turbine 112 may be coupled to a common shaft 113. A bypass passageway 130 is defined on a radially inner side by inlet turbine casing 127 and core casing 114 and on a radially outer side by engine assembly casing 101.

Gas turbine engine core 102 further comprises a core flow director 132 coupled to, mounted adjacent to, or abutting core casing 114. Core flow director 132 is selectively moveable between a first open position (illustrated in FIG. 1A) and a second shut position (illustrated in FIG. 2A). In a first open position core flow director 132 directs fluid flow in the bypass passageway 130 into the gas turbine engine core 102 as well as to continue in the bypass passageway 130. In the second shut position core flow director 132 directs fluid flow to continue in the bypass passageway 130. In some embodiments, core flow director 132 comprises a collar that is slidable along axis A between the first open position and second shut position.

Inlet turbine assembly 104 comprises an inlet turbine 118 and a turbine load component 119. In some embodiments, turbine load component 119 is a generator. In other embodiments, turbine load component 119 is a compressor. Inlet turbine assembly 104 further comprises inlet turbine casing 127 and inlet flow director 128. Inlet turbine casing encases the inlet turbine 118 and turbine load component 119.

Inlet flow director 128 directs fluid flow either through or around, or both, the inlet turbine 118. Inlet flow director 128 may comprise one or more doors, a variable area nozzle, a plurality of louvers, variable blades, rotatable grates, or the like. Inlet flow director 128 is selectively moveable between a first shut position (illustrated in FIG. 1A) and a second open position (illustrated in FIG. 2A). In a first shut position inlet flow director 128 directs fluid flow entering the engine casing 101 into the bypass passageway 130. Inlet flow director 128 in a second open position allows fluid flow entering the engine casing 101 to flow both into the bypass passageway 130 and into the inlet turbine casing 127 and thus through the inlet turbine 118.

In some embodiments inlet flow director 128 may include additional positions, such as a variable range of positions between first shut position and second open position, for throttling fluid flow into the inlet turbine casing 127. Further, in some embodiments inlet flow director 128 may be in a fully or partially open position during low Mach number operations in order to provide limited cooling of inlet air and in order to at least partially load the turbine load component 119. In embodiments where the turbine load component 119 is a generator, it may be desirable to have inlet flow director 128 in a fully or partially open position during low Mach number operations in order to generate some power.

An inlet passageway 135 is defined between the engine assembly casing 101 and forward of the inlet turbine assembly 104.

Ramburner assembly 106 comprises a fuel injection module 121 and combustion chamber 122 defined by an exhaust nozzle 123. In some embodiments exhaust nozzle 123 is a variable area exhaust nozzle. Ramburner assembly 106 further comprises a variable area bypass flow director 124 adapted to direct the flow of bypass air into the combustion chamber 122. In some embodiments the bypass flow director 124 comprises a collar slidable along axis A to a plurality of positions between a first open position and a second shut position. Variable area exhaust nozzle 123 may be adapted to produce thrust from combustion or reheating of exhaust gasses and acceleration of ramburner exit gasses. Variable area exhaust nozzle 123 may include a variable throat.

In some embodiments inlet turbine 118 may be selectively coupled to the shaft 113 of the gas turbine engine core 102. In some embodiments inlet turbine 118 and turbine load component 119 may be coupled to the shaft 113 of the gas turbine engine core 102.

FIG. 1B is a schematic view of a gas turbine engine assembly 100 configured for low Mach number operation and illustrating the fluid flowpaths within the gas turbine engine assembly 100. When configured for low Mach number operation, in some embodiments inlet flow director 128 is in a shut position, core flow director 132 is in an open position, and bypass flow director 124 is in a shut position.

Arrow A1 illustrates the flow of atmospheric fluid into the gas turbine engine assembly 100. When configured for low Mach number operation, fluid flowing into inlet region 135 is directed into bypass passageway 130 as indicated by arrow A2. The fluid flows around the inlet turbine assembly 104 (i.e. radially outward from the inlet turbine casing 127).

Arrow A3 indicates that, with the core flow director 132 in an open position, fluid continues to flow through the bypass passageway 130 but is also allowed to enter gas turbine engine core 102, where it passes through the compressor 110, combustor 111, and turbine 112.

Fluid which passes through the gas turbine engine core 102 exits as exhaust gasses, indicated by Arrow A6, which then passes through a ramburner 121 and into combustion chamber 122. Arrow A5 illustrates the continued passage of fluid through the bypass flowpath 130 which, with bypass flow director 124 in a shut position, results in the fluid continuing through the bypass passageway 130 and exiting at Arrow A8.

In low Mach number operation, the ramburner 121 may or may not be operating. If the ramburner 121 is operating, fuel is injected into exhaust gasses A6 and ignited in combustion chamber 122 for thrust augmentation. If the ramburner 121 is not operating, exhaust gasses A6 may pass through the ramburner 121, into combustion chamber 122, and exit the gas turbine engine assembly 100 through variable area exhaust nozzle 123 as shown by arrow A7.

Arrow A8 indicates that some fluid flow may continue through the bypass flowpath 130 and exits the gas turbine engine assembly 100 between the engine assembly casing 101 and the variable area exhaust nozzle 123. In some embodiments with bypass flow director 124 in a shut position all fluid flow in the bypass passageway 130 alongside or aft of the gas turbine engine core 102 will exit the gas turbine engine assembly 100 between the engine assembly casing 101 and the variable area exhaust nozzle 123.

FIG. 2A is a schematic view of a gas turbine engine assembly 100 configured for high Mach number operation. As illustrated in FIG. 2A, during high Mach number operation the inlet flow director 128 is in an open position, while the core flow director 132 is in a shut position. Bypass flow director 124 may be in an open position, a partially open position, or a shut position.

FIG. 2B is a schematic view of a gas turbine engine assembly 100 configured for high Mach number operation and illustrating the fluid flowpaths within the gas turbine engine assembly 100. Arrow A1 illustrates the flow of atmospheric fluid into the gas turbine engine assembly 100. When configured for high Mach number operation, fluid flowing into inlet region 135 is directed into bypass passageway 130 and into the inlet turbine assembly 102 as indicated by arrow A10. Fluid in the bypass passageway 130 flows around the inlet turbine assembly 104 (i.e. radially outward from the inlet turbine casing 127) and around the gas turbine engine core 102 (i.e. radially outward from the core casing 114). Bypass fluid flow is illustrated by arrow A11.

Fluid which passes through the inlet turbine assembly 104 is cooled by the inlet turbine 118 prior to flowing into the gas turbine assembly core 102, as illustrated by arrow A12. Fluid which entered the inlet turbine 118 expands while rotating the turbine 118. This expansion reduces the energy of the fluid sufficiently to reduce the fluid temperature to below temperatures which are considered degrading or damaging to the gas turbine engine core 102.

Upon entering the gas turbine assembly core 102, the fluid flows through the compressor 110, combustor 111, and turbine 112 before exiting the gas turbine assembly core 102 as exhaust gasses A14. These exhaust gasses A14 flow through a ramburner 121.

Arrow A13 indicates that fluid flowing through bypass passageway 130 may be directed into combustion chamber 122 or may continue through bypass passageway 130 before exiting the gas turbine engine assembly 100 between the engine assembly casing 101 and the variable area exhaust nozzle 123 as shown by arrow A16.

In high Mach number operation, the ramburner 121 may or may not be operating. If the ramburner 121 is operating, fuel is injected into exhaust gasses A14, mixed with bypass air shown as arrow A13, and ignited in combustion chamber 122 for thrust augmentation. If the ramburner 121 is not operating, exhaust gasses A14 may pass through the ramburner 121, into combustion chamber 122, and exit the gas turbine engine assembly 100 through variable area exhaust nozzle 123 as shown by arrow A15.

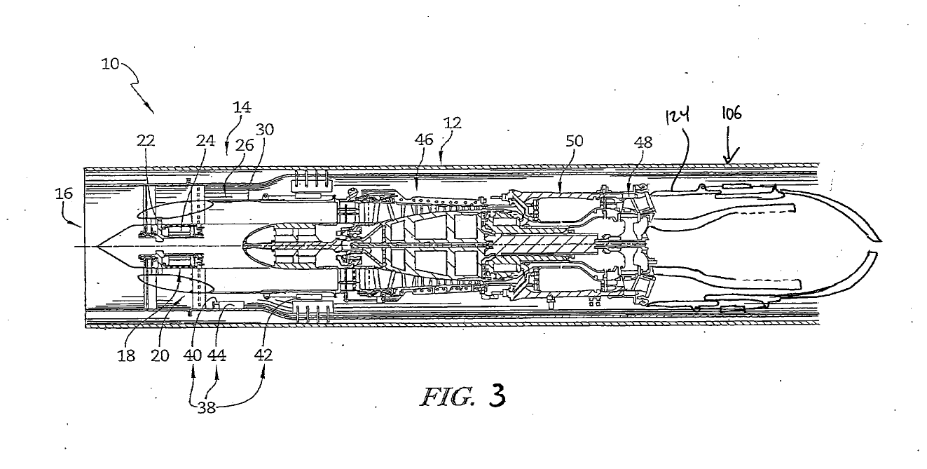

With reference now to FIGS. 3-7, an illustrative high Mach number engine 10 will now be described which is consistent with the engine 10 schematically depicted within the dotted box of FIG. 1A.

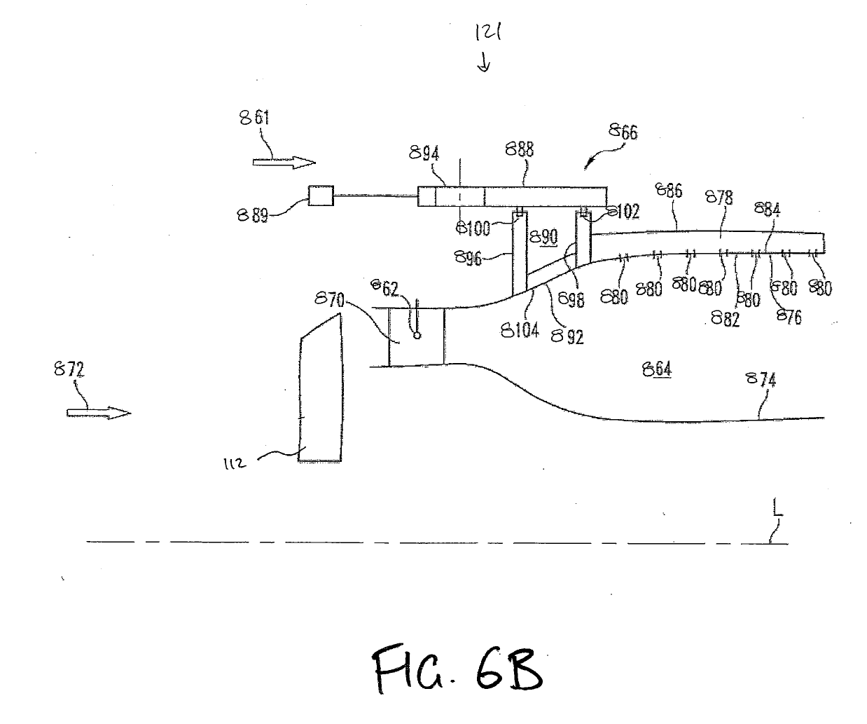

An illustrative high Mach number engine 10 includes a gas turbine core 12 and an inlet assembly 14 with an inlet turbine 22 adapted to selectively cool air that enters the gas turbine core 12 as shown in FIGS. 3-5. The gas turbine core 12 receives air from atmosphere 16 that is passed through the inlet assembly 14 and provides thrust for propelling the high Mach number engine 10. The inlet assembly 14 is coupled to the gas turbine core 12 and is located between the gas turbine core 12 and the atmosphere 16. A core flow director 26 included in the inlet assembly 14 directs air from the atmosphere 16 to interact with the inlet turbine 22 when the high Mach number engine 10 is travelling at relatively high speeds so that the air is cooled before entering the gas turbine core 12. A ramburner assembly 106 is coupled axially downstream from the gas turbine core 12 to provide thrust augmentation, and is described in greater detail with reference to FIGS. 6A and 6B below.

The gas turbine core 12 is configured to propel the high Mach number engine 10 at speeds in excess of Mach 2 and illustratively includes a compressor 46, a core turbine 48, and a combustor 50 as shown in FIG. 3. The compressor 46 compresses the air entering the gas turbine core 12 through a gas turbine inlet 52 and delivers the compressed air to the combustor 50. The combustor 50 mixes fuel with the compressed air received from the compressor 46 and ignites the fuel. The hot, high-pressure products of the combustion reaction in the combustor 50 interact with the core turbine 48 to cause the core turbine 48 to rotate about a central axis 28 and drive the compressor 46. Products of the combustion reaction, after interacting with the core turbine 48, are discharged from the gas turbine core 12 to the atmosphere 16 and provide thrust for the high Mach number engine 10.

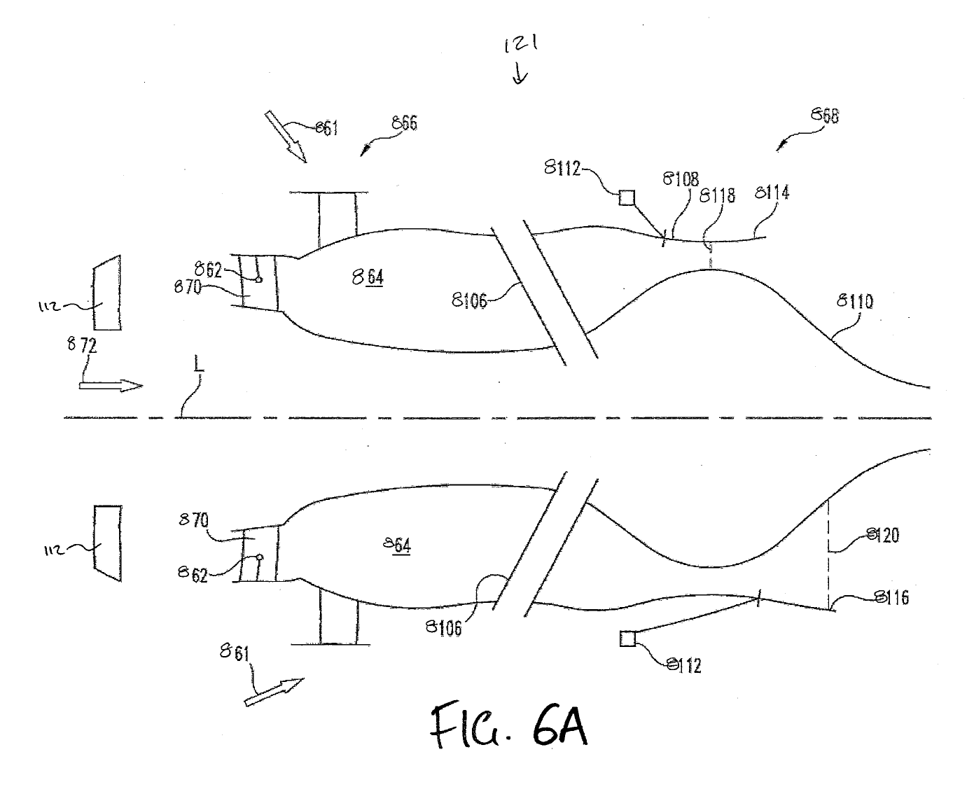

The inlet assembly 14 is mounted between the compressor 46 and the atmosphere 16 and is configured to cool air from the atmosphere 16 before it enters the compressor 46 when air temperatures are elevated because of the speed of the high Mach number engine 10 through the atmosphere 16 as suggested in FIG. 5. Structure of the inlet assembly 14 defines an inlet turbine passageway 18 and an inlet bypass passageway 20 configured so that air entering the high Mach number engine 10 must flow through either the inlet turbine passageway 18 or the inlet bypass passageway 20 in order to enter the gas turbine core 12 as shown in FIGS. 3-5.

The inlet assembly 14 illustratively includes the inlet turbine 22, a generator 24, and a core flow director 26 as shown in FIGS. 3-5. The inlet turbine 22 extends into the inlet turbine passageway 18 and can be driven by air passing through the inlet turbine passageway 18 to cooling the air by removing energy therefrom. The generator 24 is coupled to the inlet turbine 22 to provide a load on the inlet turbine 22. The core flow director 26 directs air passing through the inlet assembly 14 and is movable from an open position P1 to a closed position P2 when the high Mach number engine 10 is travelling at high-speeds so the inlet assembly 14 can cool the air entering the gas turbine core 12.

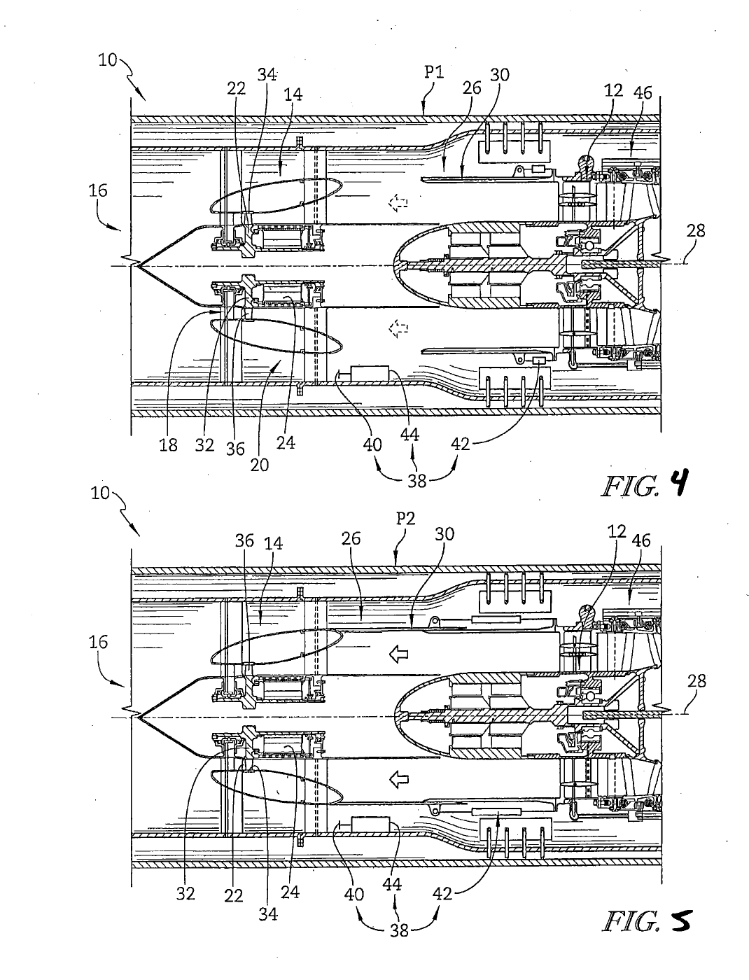

When the core flow director 26 is in the open position P1, the core flow director 26 is arranged to allow air from the inlet bypass passageway 20 to enter with the gas turbine core 12 without interacting with the inlet turbine 22 as shown in FIG. 4. When the core flow director 26 is in closed position P2 as shown in FIG. 5, the core flow director 26 is arranged such that air moving through the inlet bypass passageway 20 will continue along the bypass passageway while air passing through the inlet turbine passageway 18 and interacting with the inlet turbine 22 will continue axially downstream to interact with the gas turbine core 12. Thus with core flow director 26 in closed position P2 the air reaching the gas turbine core 12 is cooled from its interaction with the inlet turbine 22 prior to entering the gas turbine core 12.

Illustratively, the inlet turbine passageway 18 and the inlet bypass passageway 20 each form an annular ring and extend around the central axis 28 so the inlet turbine passageway 18 and the inlet bypass passageway 20 are coaxial. In the exemplary embodiment, the core flow director 26 is provided by a collar 30 that is slidable along a central axis 28 between the opened and closed positions P1, P2. The collar 30 extends around the central axis 28 and is located between the inlet turbine passageway 18 and the inlet bypass passageway 20 when in the closed position P2. In the exemplary embodiment, the collar 30 forms an annular ring and is coaxial with the inlet turbine passageway 18 and the inlet bypass passageway 20.

The inlet turbine 22 includes an inlet turbine wheel assembly 32 and an inlet turbine shroud 34 to locate the inlet turbine passageway 18 therebetween. A set of inlet turbine blades 36 extend from the inlet turbine wheel assembly 32 into the inlet turbine passageway 18 to interact with air passing through the inlet turbine passageway 18. When the core flow director 26 is in the closed position P2, air is forced to pass through the inlet turbine passageway 18 and interact with the inlet turbine 22 before entering the gas turbine core 12 causing the inlet turbine 22 to rotate.

The generator 24 is coupled to the inlet turbine 22 and provides a load to the inlet turbine 22. When the core flow director 26 is in the closed position P2, air entering the inlet turbine passageway 18 applies a force to the inlet turbine blades 36 and causing the inlet turbine 22 to rotate. The load applied by the generator 24 applies an opposite force to the inlet turbine 22 causing the inlet turbine 22 to provide resistance to the air passing through the inlet turbine passageway 18 thereby removing energy from the air and cooling the air. The electricity generated by the generator 24 can be used elsewhere in the high Mach number engine 10 or for powering a corresponding aircraft or projectile.

The high Mach number engine 10 can further include an inlet control system 38 including a sensor 40, a core flow director actuator 42, and a controller 44 coupled to the sensor 40 and the core flow director actuator 42 as shown in FIGS. 4 and 5. When the sensor 40 detects a certain parameter of the high Mach number engine 10 it sends a signal to the controller 44. When the controller 44 receives the data from the sensor 40 it directs the core flow director actuator 42 to move the core flow director 26 from the open position P1 to the closed position P2 thereby causing air entering the gas turbine core 12 to have passed through the inlet turbine passageway 18 before interacting with the gas turbine core 12. Conversely, the controller 44 may direct the core flow director actuator 42 to move the core flow director 26 to the open position, thereby allowing air to enter the gas turbine core 12 from the inlet bypass passageway 20. Moreover, in some embodiments, the controller 44 can move the core flow director 26 to various locations between the open position P1 and the closed position P2 based on data from the sensor 40.

The sensor 40 in the illustrative embodiment is configured to detect the speed of the high Mach number engine 10 moving through the atmosphere 16. When the sensor 40 detects the high Mach number engine 10 moving at a predetermined speed, the sensor 40 sends a signal to the controller 44. It is within the scope of the present disclosure for the predetermined speed to be about, or specifically Mach 4 or Mach 5. In other embodiments, the predetermined speed is less than Mach 4.

The core flow director actuator 42 is coupled to the core flow director 26 and the controller 44 as shown in FIGS. 4 and 5. The core flow director actuator 42 functions to move the core flow director 26 along the central axis 28 from the opened position P1 to the closed position P2 when the controller 44 sends a signal.

A method of operating a high Mach number engine 10 includes detecting the speed of the high Mach number engine 10 and moving a core flow director 26 from an open position P1 to a closed position P2 in response to the high Mach number engine 10 reaching a pre-determined speed as suggested in FIGS. 4-5.

The step of detecting the speed of the high Mach number engine 10 illustratively is performed by a sensor 40. Upon the speed of the high Mach number engine 10 reaching a pre-determined Mach number moving through the surrounding atmosphere 16, the sensor 40 sends a signal to the controller 44.

The step of moving the core flow director 26 from the open position P1 to the closed position P2 is performed when the controller 44 receives the signal from the sensor 40. Upon receipt of data from the sensor 40, the controller 44 sends a signal to the core flow director actuator 42 to move the core flow director 26 from the open position P1 to the closed position P2.

When the core flow director 26 is in the open position air can flow from the atmosphere 16 through the inlet bypass passageway 20 to a gas turbine core 12 without interacting with the inlet turbine 22. When the core flow director 26 is in the closed position, air is forced to flow through an inlet turbine passageway 18 to interact with the inlet turbine 22 to cool the air before reaching the gas turbine core 12.

High Mach number engines have been designed previously such that the overall engine design can be complex. Concepts involving heat exchangers and refrigeration systems have been attempted but are typically heavy and expensive and must be able to survive long periods of storage before use. Embodiments of the present disclosure do not require sealed systems that may leak and become ineffective when called upon for use after many possible years of storage.

In some embodiments, a gas turbine engine with an inlet (e.g., the high Mach number engine 10) traveling at Mach 4 or greater requires cooling such that materials in the compressor 46 are cool enough to maintain structural properties. A potential solution for cooling may be to place a turbine in the inlet (e.g., inlet turbine 22) to the high Mach number engine 10 to take energy out of the high temperature air thus cooling it prior to entry into the compressor 46. Additionally, the work extracted from the inlet turbine 22 can be converted to electricity through the use of a generator 24 for use elsewhere in the high Mach number engine 10 or airframe. The inlet turbine 22 can also be connected to an alternate compressor to provide high pressure air for use elsewhere in the engine or airframe.

The present disclosure describes a gas turbine engine architecture that contains a gas turbine core 12 with a compressor 46, combustor 50, and turbine 48 along with an additional turbine (e.g. the inlet turbine 22) that is placed in the inlet (e.g., in the inlet assembly 14) upstream from the gas turbine core 12. The purpose for placing the additional turbine (e.g. the inlet turbine 22) in the engine inlet is to remove energy in the form of heat from the high temperature air entering the engine inlet at high Mach number speeds. The inlet turbine 22 can be connected to a device such as but not limited to a generator 24 or compressor by a shaft such that the heat energy removed can be converted to another form of energy that can be used elsewhere in the engine or airframe.

With reference now to FIGS. 6A and 6B, an illustrative ramburner 121 is disclosed which is coupled axially downstream from engine 10 described above. An exemplary ramburner 121 is described by U.S. Pat. No. 9,032,737, the entirety of which is hereby incorporated by reference.

Ramburner 121 includes a fuel injector 862, a ramburner combustion chamber 864, an air injection system 866, and an exit 868. Ramburner 121 is disposed axially downstream of turbine 112As will be described below, in one form of operation the ramburner 121 includes no mechanical form of flame stabilizers; instead, a combustion flame is stabilized by an auto ignition reaction created inside the ramburner. Although the gas turbine engine 10 need not include mechanical flame stabilizers in one form of operation of the ramburner 121, in other modes of operation the gas turbine engine 10 can include flame stabilizers. The through-flow velocity of the ramburner 121 exceeds a turbulent flame speed of conventional augmenters and combustors. Therefore, to operate without mechanical flame holders and achieve auto ignition, the ramburner operates at high turbine exit temperatures to ensure that an ignition delay times are within acceptable limits. In one form of operation the ignition delay time is within 1 millisecond from a fuel injection point. By operating without mechanical flame holders, the ramburner 121 offers additional thrust capability to an air breathing gas turbine engine, without a cycle penalty due to pressure loss such as might be present in conventional augmenter designs having mechanical flame holder features.

The fuel injectors 862 provide fuel to the ramburner combustion chamber 864 downstream from the combustor 856. The fuel injectors 862 can provide any variety of fuel to the ramburner combustion chamber 864. Additionally, the fuel injectors 862 can provide a variety of fuel flow rates to the ramburner 121. The fuel injectors 862 are arranged within a turbine exit vane 870 in the illustrative embodiment, but can also be provided elsewhere within gas turbine engine 10. Though only two fuel injectors 862 are depicted in the illustrative embodiment, other embodiments can include fewer or more than two injectors. The fuel injectors in the illustrative embodiment are depicted at similar axial and radial locations, but in other embodiments the fuel injectors 862 can be at different locations. Furthermore, not all fuel injectors 862 need be located in the same structure. For example, one embodiment of the ramburner 121 can include fuel injectors located in the turbine exit vane 870 as well as in other structure.

The turbine exit vane 870 interacts with the combustion flow stream 872 and can serve to deswirl the fluid. Deswirling the fluid assists in improving axial thrust output. Any number of turbine exit vanes 870 can be used in various embodiments. Individual turbine exit vanes 870 have cambered, aerodynamic shapes, but the vanes can take on different forms in other embodiments. In addition, the turbine exit vanes 870 can be configured to have a variable pitch.

The ramburner combustion chamber 864 in the illustrative embodiment is disposed downstream of and in fluid communication with the combustor 856. In the illustrative form the ramburner combustion chamber 864 includes an inner liner 874, an outer liner 876, and a screech chamber 878. The ramburner combustion chamber 864 receives the combustion flow stream 872 from the combustor 856, the bypass flow stream 861 from the vehicle inlet 863, as well as fuel from the fuel injector 862. The ramburner combustion chamber 864 in the illustrative embodiment extends from the fuel injector 862 to the exit 868 but in some embodiments the ramburner combustion chamber 864 can extend further upstream or further downstream.

The inner liner 874 of the illustrative embodiment extends from the fuel injector 862 to the exit 868 and forms the radially inner surface of the ramburner combustion chamber 864. In one form, the inner liner 874 is configured to withstand high operating temperatures and can be passively or actively cooled. In some embodiments the inner liner 874 can partially extend upstream from the fuel injector 862. The inner liner 874 can be annular in shape, but can also take on other forms in different embodiments. In the illustrative embodiment the inner liner 874 radially expands from an outermost area near the fuel injector 862 to an innermost area as the inner liner 874 extends from the fuel injector 862 to the exit 868. Some alternative embodiments, however, may include an inner liner 874 that extends from the fuel injector 862 at a constant radial distance along an axial length of the ramburner.

The outer liner 876 of the illustrative embodiment extends from the air injector system 866 toward the exit 868. Like the inner liner 874, the outer liner 876 can be configured to withstand high operating temperatures and can be passively or actively cooled. Some embodiments of the ramburner 121 can include a portion of the outer liner 876 extending axially upstream of the air injector system 866, while the remaining portion of the outer liner extends downstream to the exit 868. The outer liner 876 can be annular in shape, but can take on other forms as well. In the illustrative embodiment the outer liner 876 is depicted as axially extending at a constant radial distance, but in some embodiments the outer liner 876 can axially extend at a varying radial distance. To set forth just one non-limiting example, the outer liner 876 may have a shape that is at least partially the mirror opposite of the inner liner 874 of the illustrative embodiment.

The outer liner 876 of the illustrative embodiment includes a series of evenly spaced apertures 880, but in some embodiments the apertures 880 may not be evenly spaced. The apertures permit interaction of fluid on either side of the outer liner 876. Each of the apertures 880 in the illustrative embodiment has a constant cross sectional area from a combustion side 882 to a screech chamber side 884. Other embodiments, however, can include the apertures 880 having a variety of cross sectional areas, or apertures that have a varying cross sectional area from the combustion side 882 to the screech chamber side 884. Some embodiments can have the apertures 880 distributed over only a portion of the outer liner 876, or distributed in select areas of the outer liner 876. Furthermore, some embodiments can include apertures 880 distributed randomly in the outer liner 876.

The screech chamber 878 is formed between the outer liner 876 and a screech surface 886 and extends from the air injector system 866 to the exit 868. In some alternative embodiments the screech chamber 878 can extend only partially between the air injector system 866 and the exit 868. The screech chamber 878 serves to mitigate acoustic instabilities and/or maintain combustion stability in the ramburner combustion chamber 864 by absorbing and/or attenuating unsteady pressure oscillations.

The air injection system 866 provides air to the ramburner combustor chamber 864 and in the illustrative form includes a sleeve 888, a plenum 890, and an air injector 892. The sleeve 888 includes an aperture 894 which permits passage of the bypass flow stream 861 and has an annular shape in the illustrative embodiment. In other embodiments, the sleeve 888 can take on forms other than annular. To set forth just one non-limiting example, in some configurations the sleeve can be a flat plate and/or can be composed of a number of individual segments that in total compose the sleeve 888. The sleeve 888 can be made from a variety of materials. The sleeve 888 is operable to move axially from a fore position to an aft position such that the aperture 894 permits passage of at least a portion of the bypass flow stream 861 to the plenum 890. In the axially fore position in the illustrative embodiment, the sleeve 888 permits minimum passage of any of the bypass flow stream 861, while in an axially aft position the sleeve 888 permits a maximum passage of the bypass flow stream 861. The sleeve can be movable to any intermediate position to permit passage of a portion of the bypass flow stream 861. Alternative embodiments can permit passage of the bypass flow stream 861 in the axially fore position while the axially aft position prohibits passage of the bypass flow stream 861. In still further embodiments, the sleeve may not permit passage at either the axially fore or aft positions, but rather permits passage at some intermediate position. Other variations of mass flow as a function of sleeve position are also contemplated herein. An actuator 89 can be used to move the sleeve 888. The actuator 889 may be any variety of actuator such as electric, pneumatic, hydraulic, or ball screw, to set forth just a few non-limiting examples.

The aperture 894 can be formed in any shape, such as rectangular or circular to set forth just a few non-limiting examples. Furthermore, the apertures 894 can have a variety of cross sectional areas. The sleeve 888 may include only one aperture 894 in some embodiments, but other embodiments can include any number of apertures 894. In those embodiments having multiple apertures, the apertures can have identical shapes and can be evenly spaced about the circumference or outer periphery of the sleeve 888. In other embodiments, however, one or more apertures, or sets of apertures, can have unique shapes, unique cross sectional areas, and can be at a variety of relative spatial locations. Furthermore, the apertures need not be evenly spaced about the periphery of the sleeve 888.

The plenum 890 in the illustrative embodiment is located between the sleeve 888, the air injector 892, an upstream radial flange 896, and a downstream radial flange 98. The plenum 890 receives at least a portion of the bypass flow stream 861 from the aperture 894 of the sleeve 888. The plenum 890 can be an annular plenum. In other embodiments, however, multiple plenums can be used and arrayed circumferentially around the gas turbine engine 10, some of which can be partially annular in shape. The plenum 890 can have any variety of internal volumes. In those embodiments having multiple plenums, the various plenums can have unique internal volumes. In the illustrative embodiment, a single aperture 894 feeds a single plenum 890. In other embodiments, however, the single aperture 894 can feed multiple plenums. In further embodiments, a single plenum can be fed by multiple apertures.

The upstream radial flange 896 and the downstream radial flange 898 in the illustrative embodiment extend radially away from a centerline L of the gas turbine engine 10. The radial flanges 896 and 898 serve to locate the sleeve 888 in the illustrative embodiment. In some embodiments, however, the radial flanges 896 and 898 can have an axial extension such that one or both of the radial flanges 896 and 898 form an angle relative to the centerline L of the gas turbine engine 10. The radial flanges 896 and 898 are formed as integral pieces in the illustrative embodiment and extend circumferentially around the gas turbine engine 10. In other embodiments, however, either or both of the radial flanges 896 and 898 can be formed as a separate number of structures that together assist in defining multiple plenums.

In the illustrative embodiment, piston rings 8100 and 8102 are located at the extreme outer end of the radial flanges 896 and 898 to provide a sealing mechanism for the bypass flow stream 861. The piston rings 8100 and 8102 can also serve to provide a sealing mechanism to prevent intrusion of exhaust gases and possible secondary cooling flows into the plenum 890, depending on the mode of operation. In some embodiments, only one piston ring may be used. For example, the piston ring 8102 can be missing. Other types of sealing arrangements are contemplated herein.

The air injector 892 can be formed within a bottom 8104 of the plenum 890 and can take the form of a slit in the illustrative embodiment. In other embodiments the bottom 8104 of the plenum 890 can be removed such that the plenum 890 is exposed to the ramburner combustion chamber 864. The air injector 892 can take on a variety of forms such as rectangular and circular, among possible others. Although only one air injector is shown in the illustrative embodiment, other embodiments can include any number of injectors, all of which can be identical in shape and evenly spaced around the circumference or outer periphery of the bottom 8104. Some embodiments can include air injectors having a variety of shapes and spacing. Furthermore, some embodiments include air injectors 892 that produce a variety of penetration depths when in use. The bottom 8104 of the air injector 892 can be formed at an angle relative to the centerline L of the gas turbine engine 10 including, but not limited to, parallel and orthogonal.

In one form the exit 868 includes struts 8106, a cowl 8108, and a plug nozzle 8110 and forms a flow path downstream of the ramburner combustion chamber 864. The struts 8106 provide support to the ramburner 121 and can be evenly spaced around the circumference of the exit 868. In some embodiments, the struts need not be evenly spaced. Though only two struts 8106 are depicted in the illustrative embodiment, fewer or more than two struts can be included in other embodiments.

The cowl 8108 is axially moveable from a fore position 8114 to an aft position 8116 in the illustrative embodiment. The cowl 8108 can be moved by an actuator 8112 which can be electric, pneumatic, or hydraulic, to set forth just three non-limiting examples.

The plug nozzle 8110 is disposed in the exit 868 of the gas turbine engine 10 and, in conjunction with the cowl 8108, provides a throat area 8118 and an exit area 8120. In some embodiments the throat area 8118 and the exit area 8120 may be defined by other structure, whether or not the structure includes the plug nozzle 8110 and the cowl 8108. The exit area 8120 and the throat area 8118 can be variable. The plug nozzle 8110 is not movable in the illustrative embodiment, but other embodiments can include a movable plug nozzle 8110.

The present disclosure provides many advantages over prior high

Mach number gas turbine engine assemblies. By selectively directing working fluid flow through the inlet turbine assembly to accomplish cooling of the working fluid, it is unnecessary to cocoon the gas turbine engine core during operation. Such cocooning, or isolating the gas turbine engine core leads to numerous operational difficulties such as the use of sealed systems which are difficult to implement and expensive to maintain; the transitioning between gas turbine engine core operation and ramburner operation; and the need to secure the gas turbine engine core during ramburner operation. Additionally, the disclosed ramburner system is available to provide thrust augmentation throughout the operation of the gas turbine engine assembly, including in the transonic phase. The need for a parallel flowpath configuration—used by many prior art designs to accomplish cocooning of the gas turbine engine core—is also unnecessary and results in a space savings. Finally, the inlet turbine generates power which is able to be directed to power onboard electronics or other accessories, or can be returned to the propulsion system in the form of thermal energy.

Although examples are illustrated and described herein, embodiments are nevertheless not limited to the details shown, since various modifications and structural changes may be made therein by those of ordinary skill within the scope and range of equivalents of the claims.

What is claimed is:

1. A high Mach number engine comprising:
a gas turbine core including a compressor, a combustor, and a turbine;
an inlet assembly coupled to the gas turbine core and configured to selectively remove energy from a working fluid prior to entering the gas turbine core when the high Mach number engine is travelling at high speeds; and
a ramburner assembly coupled to the gas turbine core and configured to selectively mix the working fluid with a bypass air upon exiting the gas turbine core and add energy to the working fluid for thrust augmentation.

2. The high Mach number engine of claim 1 wherein the inlet assembly comprises an inlet turbine disposed in an inlet turbine casing and an inlet flow director configured to selectively permit working fluid to flow through the inlet turbine.

3. The high Mach number engine of claim 2 further comprising an inlet turbine load component coupled to the inlet turbine.

4. The high Mach number engine of claim 2 further comprising an engine casing which encases the inlet turbine assembly and the gas turbine core, wherein an inlet turbine passageway is defined within the inlet turbine casing and an inlet bypass passageway is defined between the engine casing and the inlet turbine casing and is coaxial with the inlet turbine casing, and wherein the high Mach number engine further comprises a core flow director movable from (i) an open position arranged to allow working fluid from the inlet bypass passageway to move through the inlet bypass passageway and enter the gas turbine core without interacting with the inlet turbine to (ii) a closed position arranged to block air from moving through the inlet bypass passageway into the gas turbine core.

5. The high Mach number engine of claim 3 wherein the inlet turbine is configured to be driven by working fluid moving through the inlet turbine passageway thereby removing energy from the working fluid, and wherein the turbine load component is configured to apply a load on the inlet turbine.

6. The high Mach number engine of claim 1 wherein the ramburner assembly comprises a fuel injection module and an exhaust nozzle which defines a ramburning combustion chamber.

7. The high Mach number engine of claim 6 wherein the ramburner assembly further comprises a bypass flow director configured to selectively permit flow of working fluid in a bypass passageway into the ramburning combustion chamber.

8. The high Mach number engine of claim 7 wherein the bypass flow director comprises a collar mounted to slide along a central axis from an open position to a closed position.

9. The high Mach number engine of claim 8 wherein the bypass flow director is configured to throttle flow of the bypass air into the ramburning combustion chamber.

10. The high Mach number engine of claim 1 further comprising a controller coupled to the inlet assembly and the ramburner assembly to selectively configure the high Mach number engine for high Mach number operations.

11. A high Mach number engine comprising:
a gas turbine core including a compressor, a combustor and a turbine;
an inlet assembly including an inlet turbine arranged between the gas turbine core and atmosphere and a core flow director movable from (i) an opened position arranged to allow air from the atmosphere to enter the gas turbine core without interacting with the inlet turbine to (ii) a closed position arranged to block air from the atmosphere from entering the gas turbine core without interacting with the inlet turbine; and
a ramburner assembly coupled to the gas turbine core and configured to selectively mix the air upon exiting the gas turbine core with a bypass air and to selectively return energy to the air mixture for thrust augmentation.

12. The high Mach number engine of claim 11 wherein the ramburner assembly comprises a fuel injection module configured to inject fuel into the air exhausted from the gas turbine core to create an air-fuel mixture and a ramburning combustion chamber where the air-fuel mixture is combusted to provide thrust augmentation.

13. The high Mach number engine of claim 12 wherein the gas turbine core and ramburner assembly are at least partially disposed within a core casing which defines a core flowpath, and wherein the core casing is disposed within and concentric with an engine assembly casing such that a bypass flowpath is defined between the engine assembly casing and the core casing.

14. The high Mach number engine of claim 13 further comprising a bypass flow director configured to selectively permit flow of air in the bypass flowpath into the ramburning combustion chamber.

15. The high Mach number engine of claim 14 wherein the bypass flow director comprises a collar mounted to slide along a central axis, the collar configured to variably control the volume of air in the bypass flowpath which is permitted to enter the ramburning combustion chamber.

16. A method of operating an engine comprising an inlet assembly, a gas turbine core, and a ramburner assembly, the method comprising:
detecting the Mach number of the engine moving through a surrounding atmosphere with a sensor coupled to a controller;
upon detecting the high Mach number engine moving at a predetermined Mach number:
moving a core flow director from an opened position wherein air can flow from atmosphere to a gas turbine core without interacting with an inlet turbine to a closed position forcing air to interact with the inlet turbine to cool the air before reaching the gas turbine core;
mixing the gas turbine core exit air with bypass air; and
energizing the mixed air to provide thrust augmentation.

17. The method of claim 16 further comprising, upon detecting the engine moving at a predetermined speed Mach number, moving an inlet flow director from a closed position which prevents air flow across an inlet turbine to an open position which permits air flow across an inlet turbine.

18. The method of claim 16 wherein the step of reenergizing air exiting the gas turbine core comprising injecting fuel into the air in the ramburner assembly to form a fuel-air mixture and combusting the fuel-air mixture in the ramburner assembly.

19. The method of claim 18 further comprising, upon detecting the engine moving at a predetermined Mach number, throttling the flow of air in a bypass flowpath into the ramburner assembly to aide in reenergizing of air exiting the gas turbine core.

20. The method of claim 19 wherein the throttling of air is performed by a bypass flow director comprising a collar mounted to slide along a central axis and configured to slide continuously between an open position and a shut position.
